(19) United States
(12) Patent Application Publication
(10) Pub. No.: US 2008/0185964 A1
(43) Pub. Date: Aug. 7, 2008

(54) High-Pressure Discharge Lamp

(75) Inventors: Mark Josephus Lucien Maria Van Dommelen, Eindhoven (NL); Marten Willem Schuiteman, Eindhoven (NL); Leonardus Gerardus Maria Michiels, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,334

(22) PCT Filed: Apr. 27, 2006
(86) PCT No.: PCT/IB2006/051316

§ 371 Date: Nov. 1, 2007

(30) Foreign Application Priority Data
May 2, 2005 (EP) 05103639.0

(51) Int. Cl. H01J 61/30

(52) U.S. Cl. 313/634

(57) ABSTRACT

A high-pressure discharge lamp comprising an outer envelope (1) accommodating a discharge vessel (11) having a wall with an inner and an outer surface arranged around a longitudinal axis (22); the discharge vessel enclosing, in a gastight manner, a discharge space (13) provided with an ionizable filling; the discharge vessel having first and second, mutually opposite end portions (2, 3) through which a first and a second current-supply conductor (4, 5), respectively, extend to a pair of electrodes (6, 7) arranged in the discharge space. The lamp according to the invention has the special feature that the discharge vessel is provided with a weakening line (20) extending along at least a part of the circumference of the discharge vessel (11) so as to allow the discharge vessel to break into two parts along said weakening line in the case of breakage of the discharge vessel.

The present invention relates to a high-pressure discharge lamp comprising

an outer envelope accommodating a discharge vessel having a wall with an inner and an outer surface arranged around a longitudinal axis;

the discharge vessel enclosing, in a gastight manner, a discharge space provided with an ionizable filling;

the discharge vessel having first and second, mutually opposite end portions through which a first and a second current-supply conductor, respectively, extend to a pair of electrodes arranged in the discharge space.

Such a high-pressure discharge lamp is known from EP 0 549 056. In this known lamp, use is made of a glass sleeve surrounding the discharge vessel. A coiled wire, for example, a tantalum wire, is fixed as an envelope around the glass sleeve by its own clamping force. In this manner, the outer envelope of the known high-pressure discharge lamp is protected from damage in case of breakage, i.e. fragmentation of the discharge vessel, and prevents disappearance of sodium, if present, from the discharge vessel as a result of photoemission. Such breakage is also called “non-passive failure”.

The high-pressure discharge lamp as described in EP 0 549 056 mentioned above has the considerable drawback that its combined sleeve and wire construction to prevent damage of the outer envelope in the case of breakage (fragmentation) of the discharge vessel is expensive and cumbersome to install. The known lamp has the further drawback of loss of light due to reflections and absorption by the combined sleeve and wire construction.

It is an object of the invention to obviate these drawbacks of the prior art, more particularly by providing a high-pressure discharge lamp, the outer envelope of which is efficiently protected against damage (for example, when the discharge vessel unfortunately breaks at the end of its life) in an elegant, simple and cheap manner.

To achieve this object, the high-pressure discharge lamp of the type mentioned in the opening paragraph according to the invention is characterized in that the wall of the discharge vessel is provided with a weakening mark on at least a part of its circumference so as to allow the discharge vessel to break along a line over said weakening mark in the case of breakage. The essence of the present invention is that the discharge vessel will break at a predetermined location—namely at the location of said weakening mark—in a controllable manner, leaving particularly broken parts of the discharge vessel inside the outer envelope without damaging the latter. Said weakening mark particularly has the shape of a line formed by a groove or a series of spots extending along a line. The weakening mark is preferably shaped as one or more blind holes. Any particular external shape and size of the weakening mark can easily be formed by combining a series of blind holes.

In a preferred embodiment of a high-pressure discharge lamp according to the invention, said weakening line extends along the entire circumference of the wall of the discharge vessel. In other words, said groove forms a circumferential groove, while said spots extend over a circumferential line.

In another embodiment of a high-pressure discharge lamp according to the invention, said weakening mark is located at the inner surface of the discharge vessel. In a preferred alternative embodiment, said weakening mark is located at the outer surface of the discharge vessel. On the one hand, it is relatively easy to process the mark on the wall of the vessel and there is great freedom in the processing moment within the lamp fabrication process. On the other hand, the alternative embodiment has the advantage that the weakening mark will neither have any direct impact on the discharge behavior, nor on the filling of the discharge vessel.

In another preferred embodiment of a high-pressure discharge lamp according to the invention, the weakening mark is a recess in the surface of the wall of the discharge vessel, which recess has a depth varying between 0.05 mm and 0.7 mm, and is particularly less than 0.3 mm. The weakening mark is preferably a recess in the surface of the wall of the discharge vessel, with a largest width varying between 0.1 mm and 1 mm. Experiments have shown that such a dimensioned mark, for instance, a groove or a series of spots, for instance, blind holes is easy to apply and is a very controllable location for any crack of the discharge vessel, while the mark thus formed is not an optical barrier for light emitted by the discharge vessel. The recesses are preferably kept as small as possible, both in number and in size so as to minimize any effect on the lamp behavior during its normal stable operation for which it is designed.

In another preferred embodiment of a high-pressure discharge lamp according to the invention, said weakening mark is located on the wall of the discharge vessel at least substantially halfway the first and the second end portion of the discharge vessel. By providing said weakening mark halfway the first and the second end portion of the discharge vessel, the latter may break into two separate halves instead of into numerous small fragments (shattered with high speed).

It is to be noted that the weakening mark may have any arbitrary shape, for instance, a groove parallel to the axis or one or more spots shaped as a cross.

It is also to be noted that the discharge vessel may be manufactured of quartz, quartz glass or a ceramic material. A ceramic material is herein understood to be a refractory material such as a monocrystalline metal oxide (e.g. sapphire), densely sintered polycrystalline metal oxide (e.g. alumina and yttrium oxide), and densely sintered polycrystalline non-oxide material (e.g. aluminum nitride).

Furthermore, it is to be noted that EP 0 509 584 describes a high-pressure discharge lamp having a completely molded discharge vessel surface with a relief of large and deep grooves. However, the various moldings involved serve to enlarge the surface area of the discharge vessel for increased heat dissipation and do not prevent the discharge vessel from eventually breaking into numerous fragments.

These and other aspects of the high-pressure discharge lamp according to the invention will be explained with reference to the drawings, in which:

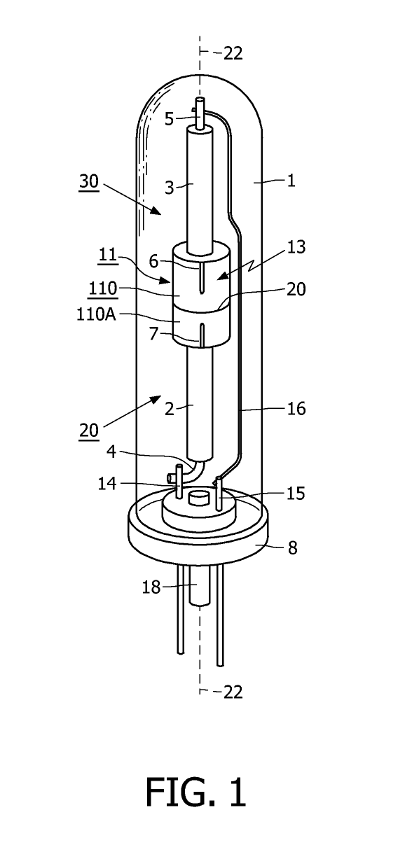

FIG. 1 diagrammatically shows a high-pressure discharge lamp according to the invention; and

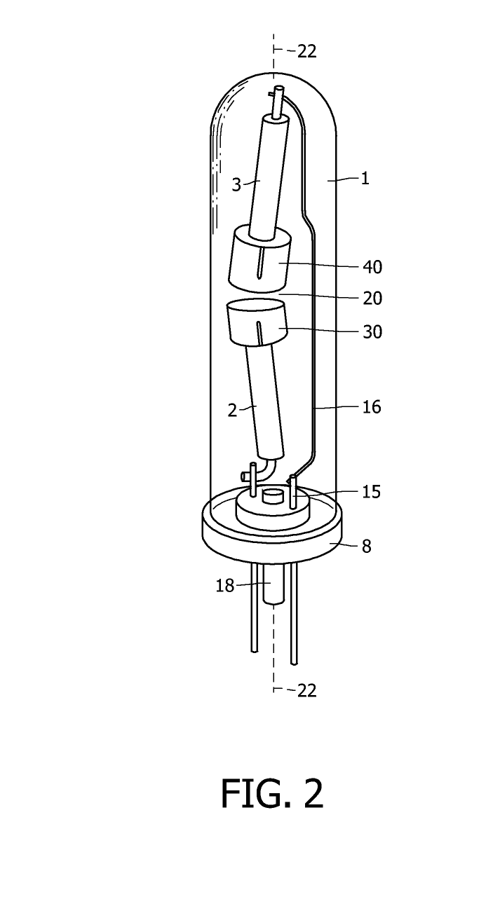

FIG. 2 shows the high-pressure discharge lamp of FIG. 1 with the discharge vessel broken along a circumferential groove on its outer side.

FIG. 1 is an artist's impression of a high-pressure discharge lamp according to the invention. The high-pressure discharge lamp comprises a discharge vessel 11 having a wall 110 with an inner and an outer surface 110A arranged around a longitudinal axis 22. The discharge vessel 11 encloses, in a gastight manner, a discharge space 13 provided with an ionizable filling comprising, for instance, mercury, a metal halide and a rare gas. The discharge vessel has first and second, mutually opposite end portions 20, 30. In the example of FIG. 1, the first and the second end portion 20, 30 are formed as a first neck-shaped portion 2 and a second, opposite neck-shaped portion 3, through which a first current-supply conductor 4 and a second current-supply conductor 5, respectively, extend to a pair of electrodes 6, 7 arranged in the discharge space 13. The high-pressure discharge lamp is further provided with a lamp base 8 made of an insulating material. The lamp base 8 supports the discharge vessel 11 via the first and second current-supply conductors 4, 5. The lamp base 8 also supports an outer bulb or outer envelope 1. In the example of FIG. 1, the lamp base 8 is provided with a first contact member 14 which is connected to the first current-supply conductor 4. The lamp base 8 is also provided with a second contact member 15 connected to the second supply conductor 5 via a connection conductor 16 running alongside the discharge vessel 1.

In an alternative embodiment, the outer envelope 1 is provided with an electric contact at both sides of the discharge vessel along the axis 22, which electric contact is connected to the respective supply conductor 4, 5.

On its outer surface 110A, the discharge vessel 11 is provided with a circumferential groove 20 forming the weakening mark, which is shaped as a recess in the surface of the wall of the discharge vessel with a depth of 0.1 mm and a largest width of 0.3 mm. Said groove 20 is located substantially halfway the first and the second end portion of the discharge vessel 11. As can be seen in FIG. 2, the discharge vessel 11 has broken into two equal halves or parts 30, 40 along said groove 20. Said groove 20 acts as a weakening line. The outer envelope 1 does not show any damage, while the discharge vessel 11 has not broken into numerous fragments.

Experiments have shown that the recess may be, for instance, square, rectangular, spherical, V or trapezoidally shaped in cross-section.

The present invention is not limited to the embodiments described with reference to FIGS. 1 and 2, but can also be used for other embodiments without departing from the scope of the appended claims.

1. A high-pressure discharge lamp comprising
an outer envelope accommodating a discharge vessel having a wall with an inner and an outer surface arranged around a longitudinal axis;
the discharge vessel enclosing, in a gastight manner, a discharge space provided with an ionizable filling;
the discharge vessel having first and second, mutually opposite end portions through which a first and a second current-supply conductor, respectively, extend to a pair of electrodes arranged in the discharge space,
characterized in that the wall of the discharge vessel is provided with a weakening mark on at least a part of its circumference so as to allow the discharge vessel to break along a line over said weakening mark in the case of breakage of the discharge vessel.

2. A high-pressure discharge lamp according to claim 1, wherein the weakening mark has a shape of a line formed by a groove or a series of spots extending along a line.

3. A high-pressure discharge lamp according to claim 1, wherein the weakening mark is shaped as one or more blind holes.

4. A high-pressure discharge lamp according to claim 2, wherein said weakening line extends along the entire circumference of the wall of the discharge vessel.

5. A high-pressure discharge lamp according to claim 1, wherein said weakening mark is located at the inner surface of the wall of the discharge vessel.

6. A high-pressure discharge lamp according to claim 1, wherein said weakening mark is located at the outer surface of the wall of the discharge vessel.

7. A high-pressure discharge lamp according to claim 1, wherein the weakening mark is a recess in the surface of the wall of the discharge vessel, which recess has a depth varying between 0.05 mm and 0.7 mm, and is particularly less than 0.3 mm.

8. A high-pressure discharge lamp according to claim 1, wherein the weakening mark is a recess in the surface of the wall of the discharge vessel, with a largest width varying between 0. 1 mm and 1 mm, particularly between 0.2 mm and 0.5 mm.

9. A high-pressure discharge lamp according to claim 1, wherein said weakening mark is located on the wall of the discharge vessel at least substantially halfway the first and the second end portion of the discharge vessel.
